(19) United States
(12) Patent Application Publication
(10) Pub. No.: US 2006/0204747 A1
(43) Pub. Date: Sep. 14, 2006

(54) Multilayer, transparent polyester film with high oxygen barrier

(76) Inventors: Dagmar Klein, Ockenheim (DE); Herbert Peiffer, Mainz (DE); Gottfried Hilkert, Saulheim (DE)

Correspondence Address: PROPAT, L.L.C., 425-C SOUTH SHARON AMITY ROAD, CHARLOTTE, NC, 28211-2841, US

(21) Appl. No.: 11/370,359

(22) Filed: Mar. 8, 2006

(30) Foreign Application Priority Data
Mar. 12, 2005 (DE) 10 2005 011 469.5

(51) Int. Cl. B32B 27/36; B29C 47/06; B29C 55/14

(52) U.S. Cl. 428/339; 428/910; 428/480; 264/173.16; 264/235.8

(57) ABSTRACT

The invention relates to a transparent, biaxially oriented polyester film with a base layer B formed from at least 80% by weight of a thermoplastic polyester, and with at least one outer layer A. The outer layer A includes polyesters and poly(m-xyleneadipamide) in certain concentrations. The invention further relates to the use of the film and to a process for its production. The transparent film has very low atmospheric-oxygen transmission and exhibits very good adhesion between the respective layers. It is particularly suitable for packaging purposes, specifically for the packaging of foods and of other consumable items.

### CROSS-REFERENCE TO RELATED APPLICATIONS

This application claims priority to parent German Patent Application No. 10 2005 011 469.5, filed Mar. 12, 2005, hereby incorporated by reference herein in its entirety.

### FIELD OF THE INVENTION

The invention relates to a transparent, biaxially oriented polyester film with a base layer B which is comprised of at least 80% by weight of a thermoplastic polyester, and with at least one outer layer A. The outer layer A comprises polyesters and poly(m-xyleneadipamide) in certain concentrations. The invention further relates to the use of the film and to a process for its production.

### BACKGROUND OF THE INVENTION

Transparent biaxially oriented polyester films which feature improved barrier properties are known in the prior art.

EP-A-0 878 297 describes a transparent biaxially oriented polyester film with a base layer B and with at least one outer layer A. The outer layer A is comprised of a mixture of polymers which comprises at least 40% by weight of ethylene 2,6-naphthalate units and up to 40% by weight of ethylene terephthalate units, and/or up to 60% by weight of units derived from cycloaliphatic or aromatic diols and/or dicarboxylic acids. The film is unsatisfactory with respect to barrier properties, in particular oxygen-barrier properties, and in relation to internal adhesion and ease of production.

EP-1 179 418 A2 describes a transparent, biaxially oriented polyester film with a base layer B and with at least one outer layer A. The outer layer A here is comprised of a copolymer or mixture of polymers/copolymers, which comprises from 90 to 98% by weight of ethylene 2,6-naphthalate units and up to 10% by weight of ethylene terephthalate units, and/or units derived from cycloaliphatic or aromatic diols and/or dicarboxylic acids. Its thickness is more than 0.7 μm and it makes up less than 25% by weight of the entire film. The transparent film has very low atmospheric-oxygen transmission, and exhibits very good adhesion between the respective layers. However, the film remains unsatisfactory in relation to barrier properties, in particular oxygen-barrier properties.

WO 99/62694 describes a process in which a multilayer, coextruded polyester film, which also comprises at least one layer comprised of EVOH, is simultaneously biaxially oriented. The film in particular features good barrier properties with respect to passage of oxygen. The specification gives 5 cm³/(m²·bar·d) as best value for achievable oxygen transmission (OTR). However, a disadvantage of the process is that cut film produced during the production process cannot be reintroduced in the form of regrind into the process without loss of the good optical properties of the resultant film.

EP-A-1 457 316 describes a multilayer, transparent, biaxially oriented polyester film with a base layer B and with at least one outer layer A applied to this base layer B, wherein the base layer B and the outer layer A comprise poly(m-xyleneadipamide) (MXD6). The polyester film has better optical properties than films of the prior art, in particular increased gloss. The film moreover features good barrier properties, in particular with respect to passage of oxygen.

### SUMMARY OF ADVANTAGEOUS EMBODIMENTS OF THE INVENTION

It was therefore an object of the present invention to provide a transparent, biaxially oriented polyester film with a base layer B and with at least one outer layer A, which eliminates the disadvantages of films of the prior art and which in particular features
improved barrier properties, in particular with respect to oxygen,
improved adhesion between the respective layers,
improved gloss of the outer layer A,
low roughness values for the outer layer A, so that the film can easily be metallized or can easily be vacuum-coated with transparent materials (SiOₓ, Al₂O_{y}),
has improved winding performance and improved processing performance, and
permits particularly cost-effective production. In this connection, the intention is to ensure that an amount of up to 60% by weight of cut film material produced during large-scale industrial production in a factory can be reintroduced as regrind to the extrusion process without any resultant adverse effect on the optical properties of the film, but in particular on its barrier properties with respect to oxygen.

### BRIEF DESCRIPTION OF THE DRAWINGS

FIG. 1 is an exemplary cumulative particle size distribution curve illustrating d₅₀; and

FIG. 2 is an exemplary cumulative particle size distribution curve illustrating d₁₀ and d₉₈.

### DETAILED DESCRIPTION OF ADVANTAGEOUS EMBODIMENTS OF THE INVENTION

This object is achieved via a transparent, biaxially oriented polyester film with a base layer B which is comprised of at least 80% by weight of a thermoplastic polyester, and with at least one outer layer A, comprised of a mixture of homo- and/or copolymers which comprises, based on the total weight of the outer layer A,
an amount of from 5 to 65% by weight of ethylene terephthalate and/or ethylene isophthalate units,
an amount of from 20 to 80% by weight of ethylene 2,6-naphthalate units and
an amount of from 15 to 40% by weight of poly(m-xyleneadipamide) (MXD6).

The oxygen transmission of the inventive film is less than 80 cm³/(m²·bar·d), and its minimum adhesion between the layers A and B is greater than or equal to 1.0 N/15 mm.

The inventive film preferably has a three-layer structure. It is then comprised of the outer layer A, of the base layer B, and of another outer layer C.

Base Layer B

The base layer of the film is preferably comprised of at least 90% by weight of a thermoplastic polyester. Polyesters suitable for this purpose are those comprised of ethylene glycol and terephthalic acid(=polyethylene terephthalate, PET), of ethylene glycol and naphthalene-2,6-dicarboxylic acid(=polyethylene 2,6-naphthalate, PEN), of 1,4-bishydroxymethylcyclohexane and terephthalic acid(=poly(1,4-cyclohexanedimethylene terephthalate, PCDT), or else of ethylene glycol, naphthalene-2,6-dicarboxylic acid, and biphenyl-4,4′-dicarboxylic acid(=polyethylene 2,6-naphthalate bibenzoate, PENBB). Particular preference is given to polyesters comprised of at least 90 mol %, preferably at least 95 mol %, of ethylene glycol units and terephthalic acid units or of ethylene glycol units and naphthalene-2,6-dicarboxylic acid units. The remaining monomer units derive from other diols and, respectively, dicarboxylic acids. Examples of suitable diol comonomers are diethylene glycol, triethylene glycol, aliphatic glycols of the formula HO—(CH₂)ₙ—OH, where n is a whole number from 3 to 6, branched aliphatic glycols having up to 6 carbon atoms, aromatic diols of the formula HO—C₆H₄—X—C₆H₄—OH, where X is —CH₂—, —C(CH₃)₂—, —C(CF₃)₂—, —O—, —S—, or —SO2—, or bisphenols of the formula HO—C₆H₄—C₆H₄—OH.

The dicarboxylic acid comonomer units preferably derive from benzenedicarboxylic acids, napthalenedicarboxylic acids, biphenyl-x,x′-dicarboxylic acids (in particular biphenyl-4,4′-dicarboxylic acid), cyclohexanedicarboxylic acids (in particular cyclohexane-1,4-dicarboxylic acid), diphenylacetylene-x,x′-dicarboxylic acids (in particular diphenylacetylene-4,4′-dicarboxylic acid), stilbene-x,x′-dicarboxylic acid, or C₁-C₁₆ alkanedicarboxylic acids, where the alkane content can optionally be straight-chain or branched.

The polyesters can be prepared by the. transesterification process. This process starts from dicarboxylic esters and from diols, which are reacted using the conventional transesterification catalysts, such as the salts of zinc, of calcium, of lithium, and of manganese. The precursors are then polycondensed in the presence of well known polycondensation catalysts, such as antimony trioxide or titanium salts. They can equally well be prepared by the direct esterification process in the presence of polycondensation catalysts. This process starts directly from the dicarboxylic acids and from the diols.

Outer Layer A

The outer layer A comprises an amount of from 5 to 65% by weight of ethylene terephthalate and/or ethylene isophthalate units. It preferably comprises an amount of from 6 to 64% by weight of these starting materials, and particularly preferably an amount of from 7 to 63% by weight. In principle, the (polyester) polymers used for the outer layer A can be identical with those used for the base layer B, in particular polyethylene terephthalate can be used.

It is particularly advantageous for the outer layer A to use a polyester copolymer based on isophthalic acid and terephthalic acid. In this case the optical properties of the film are particularly good. The outer layer A of the film here in essence comprises a polyester copolymer comprised mainly of isophthalic acid units and of terephthalic acid units and of ethylene glycol units. The remaining monomer units derive from the other aliphatic, cycloaliphatic, or aromatic diols and, respectively, dicarboxylic acids that can also occur in the base layer. The preferred copolyesters which give the film the desired properties are those comprised of terephthalate units and of isophthalate units and of ethylene glycol units. The content, of ethylene terephthalate is from 60 to 97 mol % and the corresponding content of ethylene isophthalate is from 40 to 3 mol %. Preference is given to copolyesters in which the content of ethylene terephthalate is from 70 to 95 mol % and the corresponding content of ethylene isophthalate is from 30 to 5 mol %.

The outer layer A moreover comprises an amount of from 20 to 80% by weight of ethylene 2,6-naphthalate units. It preferably comprises an amount of from 22 to 78% by weight, and particularly preferably an amount of from 24 to 76% by weight, of this starting material.

According to the invention, another component present in the outer layer A is poly(m-xyleneadipamide) (MXD6), its amount being from 15 to 40% by weight, preferably from 16 to 39% by weight, and particularly preferably from 17 to 38% by weight, based on the weight of the outer layer A.

The thickness of the outer layer A is greater than 0.9 μm and is preferably in the range from 1.0 to 10 μm, and particularly preferably in the range from 1.1 to 5 μm.

The roughness Rₐ of the surface A of the film is smaller than 100 nm. In one preferred embodiment, the roughness Rₐ of the surface A of the film is less than 80 nm, and in one particularly preferred embodiment the roughness Rₐ of the surface A of the film is less than 60 nm.

The gloss (measured at an angle of 60°) of the surface A of the film is greater than 150. In one preferred embodiment, the gloss of this side is more than 155, and in one particularly preferred embodiment it is more than 160.

This surface of the film is therefore particularly suitable for a further functional coating, for printing, or for metalizing. The high gloss of the film transfers to the print or to the metal layer applied and thus gives the film the desired appearance which is effective for promotional purposes.

Outer Layer C

The starting materials of which the outer layer C is comprised are in essence identical with those of the base layer B. To achieve good winding performance and good processibility of the film, the outer layer C comprises a pigment system in which the median diameter (d₅₀ value) is in the range from 2.0 to 5.0 μm and the SPAN98 is in the range from 1.2 to 2.0.

In one preferred embodiment, the outer layer C comprises a pigment system in which the median diameter is in the range from 2.1 to 4.9 μm and the SPAN98 is in the range from 1.25 to 1.9. In the particularly preferred embodiment, the outer layer C comprises a pigment system in which the median diameter is in the range from 2.2 to 4.8 μm and the SPAN98 is in the range from 1.3 to 1.8.

The outer layer C is comparatively highly filled with inert pigments (particles) in order to improve winding performance and processibility. The concentration of the inert particles in the outer layer C is from 0.10 to 0.4% by weight, and in the preferred embodiment is from 0.14 to 0.38% by weight, and in the particularly preferred embodiment is from 0.16 to 0.36% by weight, and depends in essence on the optical properties to be achieved in the film.

The outer layer C can comprise an amount of from 10 to 45% by weight, preferably from 11 to 43% by weight, and particularly preferably from 12 to 40% by weight, based on the outer layer C, of poly(m-xyleneadipamide) (MXD6), alongside the pigments.

The roughness Rₐ of the surface C of the film is greater than 40 nm. In one preferred embodiment, the roughness Rₐ of the surface C of the film is more than 45 nm and in one particularly preferred embodiment the roughness Rₐ of the surface C of the film is more than 50 nm.

The thickness of the outer layer C is greater than 0.9 μm and is preferably in the range from 1.0 to 10 μm, and A particularly preferably in the range from 1.1 to 5 μm.

The total thickness of the inventive polyester film is from 6 to 300 μm, preferably from 8 to 200 μm, particularly preferably from 10 to 100 μm, and the proportion made up here by the base layer (B) is preferably from 40 to 99% of the total thickness.

The base layer B and the two outer layers A and C can also comprise conventional additives, such as stabilizers and antiblocking agents. They are advantageously added to the polymer or to the polymer mixture before melting begins. Examples of stabilizers used are phosphorus compounds, such as phosphoric acid or phosphoric esters. Typical antiblocking agents, often also termed pigments in this context, are inorganic and/or organic particles, such as calcium carbonate, amorphous silica, talc, magnesium carbonate, barium carbonate, calcium sulfate, barium sulfate, lithium phosphate, calcium phosphate, magnesium phosphate, aluminum oxide, lithium fluoride, the calcium, barium, zinc, or manganese salts of the dicarboxylic acids used, carbon black, titanium dioxide, kaolin, or crosslinked polystyrene particles or crosslinked acrylate particles.

Other additives that can be selected are mixtures of two or more different antiblocking agents or mixtures of antiblocking agents of the same constitution but different particle size. The concentrations of the particles added to the respective layers can be those intended for this purpose, e.g. in the form of a glycolic dispersion during the polycondensation reaction, or by way of masterbatches during the extrusion process.

The antiblocking agents present in the outer layer A are generally identical with those of the outer layer C, at identical concentration.

In one preferred embodiment of the invention, the filler content in the outer layer A is less than 0.1% by weight and particularly preferably less than 0.05% by weight.

Process

The invention also provides a process for production of the film. To produce the base layer B, the polyester pellets are advantageously directly fed to the extruder for the base layer B. The polyester pellets can be extruded at from about 270 to 300° C.

Each of the polymers for the outer layers A and C is advantageously fed by way of further extruders to the coextrusion system, and in principle twin-screw extruders are preferable to single-screw extruders here, in particular for outer layer A. Because MXD6 becomes unstable at temperatures above 275° C., the operating temperature of the coextruder for the outer layer A is not above 275° C. The melts are shaped in a coextrusion die to give flat melt films and are mutually superposed in the form of layers. The multilayer film is then drawn off with the aid of a chill roll and, if appropriate, other rolls, and solidified.

The biaxial stretching process is generally carried out sequentially. It is preferable here to stretch longitudinally first (i.e. in machine direction) and then transversely (i.e. perpendicularly to machine direction). The longitudinal stretching can be carried out with the aid of two rolls rotating at different speeds corresponding to the desired stretching ratio. For the transverse stretching process, an appropriate tenter frame is generally used.

The temperature at which the stretching process is carried out can vary relatively widely, and depends on the desired properties of the film. The longitudinal stretching is generally carried out in the temperature range from 80 (heating temperatures from 80 to 130° C.) to 130° C. (stretching temperatures from 80 to 130° C., as a function of stretching ratio), and the transverse stretching is generally carried out in the temperature range from 90 (start of stretching) to 140° C. (end of stretching). The longitudinal stretching ratio is in the range from 2.0:1 to 5.0:1, preferably from 2.3:1 to 4.8:1. The transverse stretching ratio is generally in the range from 2.5:1 to 5.0:1, preferably from 2.7:1 to 4.5:1.

Prior to the transverse stretching, one or both surfaces of the film can be in-line coated by the known processes. By way of example, the in-line coating process can lead to improved adhesion of a metal layer or of any printing ink applied, but can also lead to improvement in antistatic performance, or in processing performance, or to further improvement in barrier properties. This can be achieved, if appropriate, via application of barrier coatings, for example those comprising EVOH, PVOH, or the like. Layers of this type are then preferably applied to the smoother (=less rough) surface of the film.

In the heat-setting process which follows, the film is kept at a temperature of from 150 to 250° C. for a period of from about 0.1. to 10 s. The film is then wound up conventionally.

It has been ensured that during production of the inventive film an amount of up to 60% by weight, preferably from 10 to 50% by weight, in each case based on the total weight of the film, of cut material produced directly in the factory during film production can be reused as regrind for film production, without any significant resultant adverse effect on the physical properties of the film.

The inventive film has excellent suitability for metalizing or for vacuum coating with ceramic substances. It very particularly features excellent barrier properties, in particular with respect to oxygen.

The table below (table 1) again collates the most important inventive film properties.

TABLE 1

| | Inventive | | Particularly | | Test |
|---|---|---|---|---|---|
| | range | Preferred | preferred | Unit | method |
| Outer layer A | | | | | |
| Ethylene terephthalate/isophthalate units | 5-65 | 6-64 | 7-63 | | |
| Ethylene 2,6-naphalate units | 20-80 | 22-78 | 24-76 | | |
| Poly(m-xyleneadipamide) (MXD6) | 15-40 | 16-39 | 17-38 | | |
| Thickness of outer layer A | >0.9 | 1.0-10 | 1.1-5 | μm | |
| Filler concentration of pigment system | 0.10-0.40 | <0.10 | <0.05 | % | internal |
| Roughness of outer layer A | <100 | <80 | <60 | nm | DIN 4768 |
| Gloss of outer layer A (measurement angle: 60°) | >150 | >155 | >160 | | DIN 67530 |
| Outer layer C | | | | | |
| Filler concentration of pigment system | 0.10-0.4 | 0.14-0.38 | 0.16-0.36 | % | internal |
| d₅₀ particle diameter of pigment system | 2.0-5 | 2.1-4.9 | 2.2-4.8 | μm | internal |
| SPAN98 of pigment system | 1.2-2.0 | 1.25-1.9 | 1.3-1.8 | μm | internal |
| Roughness of outer layer C | >40 | >45 | >50 | nm | DIN 4768 |
| Thickness of outer layer C | >0.9 | 1.0-10 | 1.1-5 | μm | |
| Film properties | | | | | |
| Oxygen transmission | <80 | <78 | <76 | Cm³/(m² · bar · d) | internal |
| Adhesion between layers | 1.0-10 | 1.2-10 | 1.5-10 | N/15 mm | internal |

An amount of from 5 to 65% by weight of ethylene terephthalate units and/or of ethylene isophthalate units

An amount of from 20 to 80% by weight of ethylene 2,6-naphthalate units

Test Methods

The following methods were used to characterize the starting materials and the films:

Oxygen Transmission

Oxygen barrier was measured using an OX-TRAN 2/20 from Mocon Modern Controls (USA) to DIN 53 380, part 3.

SV Value (Standard Viscosity)

Standard viscosity SV (DCA) is measured by a method based on DIN 53726, at 25° C. in dichloroacetic acid. Intrinsic viscosity (IV) is calculated as follows from the standard viscosity
IV=[η]=6.907·10⁻⁴SV(DCA)+0.063096[dl/g]

Roughness

Roughness Rₐ of the film was determined to DIN 4768 with a cut-off of 0.25 mm. This test was not carried out on a glass plate, but in a ring. In the ring method, the film is clamped into a ring so that neither of the two surfaces is in contact with a third surface (e.g. glass).

Gloss

Gloss was determined to DIN 67 530. Reflectance was measured, this being a characteristic optical variable for a film surface. Using a method based on the standards ASTM-D523-78 and ISO 2813, the angle of incidence was set at 60°. A beam of light hits the flat test surface at the set angle of incidence and is reflected and/or scattered by the surface. A proportional electrical variable is displayed, representing the light rays hitting the photoelectric detector. The value measured is dimensionless and has to be stated together with the angle of incidence.

Measurement of Median Particle Diameter d₅₀

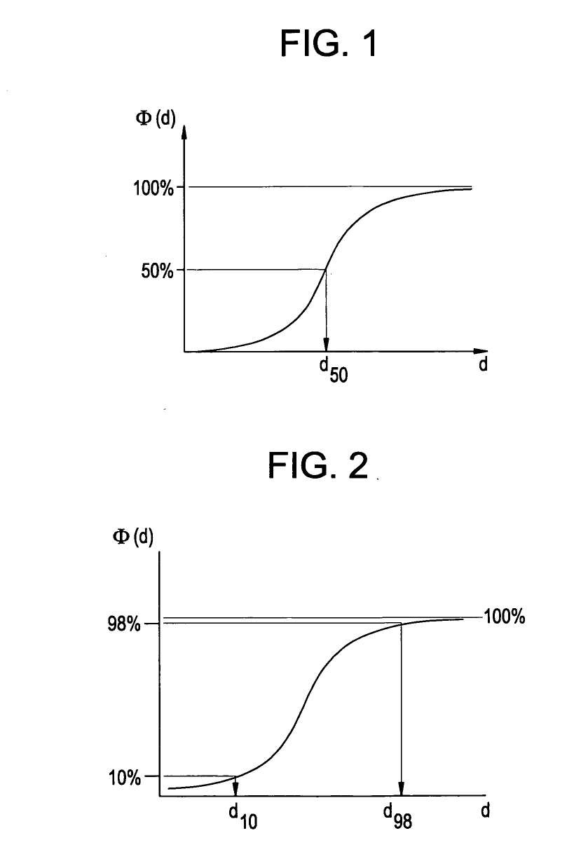

Median particle diameter d₅₀ was determined by means of a laser on a Malvern Mastersizer by the standard method (examples of other test equipment being the Horiba LA 500 or Sympathec Helos, which use the same principle of measurement). For this, the specimens were placed with water in a cell and the cell was then placed in the test equipment. The test procedure is automatic and also includes mathematical determination of the d₅₀ value. The d₅₀ value is defined here as being determined from the (relative) cumulative curve of particle size distribution: the intersect of the 50% ordinate value with the cumulative curve gives the desired d₅₀ value on the abscissa axis. (cf. FIG. 1).

Measurement of SPAN98

The test equipment used to determine SPAN98 was the same as that described for determination of median diameter d₅₀. SPAN98 is defined here as follows:

$$SPAN 98 = \frac{{ⅆ}_{98} - {d}_{10}}{{ⅆ}_{50}}$$

Determination of d₉₈ and d₁₀ is in turn based on the cumulative particle size distribution curve. The intersect of the 98% ordinate value with the cumulative curve gives the desired d₉₈ value on the abscissa axis, and the intersect of the 10% ordinate value of the cumulative curve gives the desired d₁₀ value on the abscissa axis (cf. FIG. 2).

Adhesion Between Layers

Prior to adhesive bonding, the specimen of film (300 mm long×180 mm wide) is placed on a smooth piece of card (200 mm long×180 mm wide; about 400 g/m², bleached, outer layers coated), and the overlapping margins of the film are to be folded back onto the reverse side and secured with adhesive tape.

For adhesive bonding of the film according to the present invention, a standard polyester film of thickness 12 μm is used, with a doctor device and doctor bar No. 3 from Erichsen, applying about 1.5 ml of adhesive (Novacote NC 275+CA 12; mixing ratio: 4/1+7 parts of ethyl acetate) to the outer layer A of the film according to the present invention. After aerating to remove the solvent, the standard polyester film is laminated to the outer layer A of the film according to the present invention, using a metal roller (width 200 mm, diameter 90 mm, weight 10 kg, to DIN EN 20 535). The lamination parameters are:

| | |
|---|---|
| Amount of adhesive: | 5 ± 1 g/m² |
| Aeration of application of adhesive: | 4 min ± 15 s |
| Doctor thickness (Erichsen): | 3 |
| Doctor speed level: | about 133 mm/s |
| Bond curing time: | 2 h at 70° C. in a drying |
| | cabinet air circulation |

A 20±1 mm strip cutter is used to take specimens of length about 100 mm. About 50 mm of composite and 50 mm of unbonded separate layers are needed here for securing/clamping the test specimen. The reverse side of the film of the test specimens is to be secured to a sheet metal support over the entire surface by means of double-sided adhesive tape. The sheet with the composite adhesive-bonded thereto is to be fixed to a peel tester. The unlaminated end of the standard polyester film is to be clamped into the clip of the peel tester (e.g. Instron, Zwick) in such a way as to give a peeling angle of 180°. The average peel force in N/15 mm is stated, rounded to one decimal point.

| | | |
|---|---|---|
| Specimen width | 20 | mm |
| Test length: | 25 | mm |
| Separation rate until pretensioning force applied: | 25 | mm/min |
| Start position: | 5 | mm |
| Test displacement: | 40 | mm |
| Sensitivity: | 0.01 | N |
| Separation rate: | 100 | mm/min |

The peel force test result is equivalent to the minimum adhesion between the layers, because adhesion between the adhesive and the standard film is markedly greater. By way of example, a UV lamp can be used to detect separation of layers between the outer layer A and the base layer B of the film according to the present invention. If copolymer comprised of PEN and PET appears on the adhesive, when this layer is irradiated using a UV lamp, the UV light acquires a bluish appearance.

### EXAMPLES

The examples below illustrate the invention. The products used (trademark and producer) are in each case stated only once, and then also apply to the subsequent examples.

### Inventive Example 1

Chips comprised of polyethylene terephthalate, poly-ethylene 2,6-naphthalate, and MXD6 were fed directly to the extruder (=vented twin-screw extruder) for the outer layer A in a mixing ratio of 40/20/40. Materials were extruded at a temperature of about 275° C. The melt was filtered, shaped in a coextrusion die to give a flat film, and superposed in the form of outer layer A on the base layer B.

Chips comprised of polyethylene terephthalate were dried at a temperature of 160° C. to a residual moisture level of less than 100 ppm, and fed to the extruder for the base layer B. Alongside this, chips comprised of polyethylene terepbthalate and antiblocking agent were likewise dried at 160° C. to a residual moisture level of 100 ppm and fed to the extruder for the outer layer C. The operating temperature of the extruder for the outer layer C was higher by about 10 K than that of coextruder A.

Coextrusion followed by stepwise longitudinal and transverse orientation was used to produce a transparent three-layer ABC film whose total thickness was 12 μm. The thickness of the outer layer A was 1.3 μm and that of the outer layer C was 1.0 μm.

| | |
|---|---|
| Outer layer A: | |
| 40% by weight | of poly(m-xyleneadipamide) (MXD6) from Mitsubishi |
| | Gas Chemical Co., product name Nylon MXD6 |
| 20% by weight | of polyethylene 2,6-naphthalate (Polyclear ® |
| | P 100 prepolymer from Invista/Offenbach) with an |
| | SV value of 600 |
| 40% by weight | of polyethylene terephthalate (4023 from |
| | Invista/Offenbach) with an SV value of 800 |
| Base layer B: | |
| 100% by weight | of polyethylene terephthalate (4023 from |
| | Invista/Offenbach) with an SV value of 800 |
| Outer layer C: | |
| 80% by weight | of polyethylene terephthalate with an SV value of |
| | 800 |
| 20% by weight | of masterbatch comprised of 97.75% by weight of |
| | polyethylene terephthalate (SV value of 800) and |
| | 1.0% by weight of Sylobloc ® 44 H (synthetic SiO₂ |
| | from Grace), and 1.25% by weight of Aerosil ® TT |
| | 600 (chain-type SiO₂ from Degussa) |

The production conditions in the individual steps of the process were:

| | | | |
|---|---|---|---|
| Extrusion | Temperatures | Layer A: | 275° C. |
| | | Layer B: | 290° C. |
| | | Layer C: | 285° C. |

| | | |
|---|---|---|
| | Take-off roll temperature | 25° C. |
| Longitudinal stretching | Stretching temperature | 115° C. |
| | Longitudinal stretching ratio | 4.0 |
| Transverse stretching | Stretching temperature | 125° C. |
| | Transverse stretching ratio | 3.9 |
| Fixing | Temperature | 230° C. |
| | Duration | 3 s |

The film had the oxygen barrier required and the required mutual adhesion of the layers.

### Inventive Example 2

As in inventive example 1, coextrusion was used to produce a three-layer ABC film whose total thickness was 12 μm. The thickness of the outer layer A was 1.8 μm and the thickness of the outer layer C was 1.0 μm.

### Comparative Example CE1

A film was produced corresponding to example 8 of EP-A-0 878 298. The film metalized on the outer layer A had the oxygen barrier required, but adhesion between the layers A and B was extremely small.

### Comparative Example CE2

A film was produced corresponding to example 1 of U.S. Pat. No. 5,795,528. However, in contrast to the example from U.S. Pat. No. 5,795,528, only two layers comprised of PEN and PET were selected. The film metalized on the PEN surface had the oxygen barrier required, but adhesion between the layers A and B was extremely small.

Table 2 lists the properties of the films produced according to inventive examples IE1 and IE2 and comparative examples CE1 and CE2.

TABLE 2

| | | | Layer | | | | Adhesion | Roughness | Gloss of | | |
|---|---|---|---|---|---|---|---|---|---|---|---|
| | Film | | thicknesses | | | Oxygen | between | of outer | side A, | | |
| | thickness | Film | in μm | | | transmission | layers | layer A | measurement | Winding | Processing |
| | in μm | structure | A | B | C | cm³/(m² · bar · d) | N/15 mm | nm | angle 60° | performance | performance |
| IE1 | 12 | ABC | 1.3 | 9.7 | 1 | 78 | 2 | 35 | 163 | ++++ | ++++ |
| IE2 | 12 | ABC | 1.8 | 9.2 | 1 | 75 | 2.5 | 34 | 167 | ++++ | ++++ |
| CE1 | 12 | ABC | 3 | 7.5 | 1.5 | 50 | 0.1 | 22 | 170 | ++ | + |
| CE2 | 12 | ABAB | | | | 45 | 0.1 | | | − | − |

Key to winding performance and processing performance of films:
++++ No tendency to stick to rolls or to other mechanical parts, no blocking problems on winding or on processing on packaging machinery, low production costs
+ Moderate production costs
− Tendency to stick to rolls or to other mechanical parts, blocking problems on winding and on processing on packaging machinery, high production costs due to complicated handling of the film in the machinery

1. A transparent, biaxially oriented polyester film comprising a base layer B which comprises at least 80% by weight of a thermoplastic polyester, and at least one outer layer A, wherein said outer layer A includes a mixture of homo- and/or copolymers which comprises, based in each case on the total weight of the outer layer A,
(i) an amount of from 5 to 65% by weight of ethylene terephthalate and/or ethylene isophthalate units,
(ii) an amount of from 20 to 80% by weight of ethylene 2,6-naphthalate units and
(iii) an amount of from 15 to 40% by weight of poly(m-xyleneadipamide).

2. The transparent film as claimed in claim 1, wherein the thickness of the outer layer A is more than 0.9 μm.

3. The transparent film as claimed in claim 1, whose oxygen transmission is less than 80 cm³/(m²·bar·d)

4. The transparent film as claimed in claim 1, wherein the adhesion between the individual layers is from 1.0 to 10 N/15 mm.

5. The transparent film as claimed in claim 1, whose structure has three layers, and which comprises a base layer B, an outer layer A, and an outer layer C.

6. The transparent film as claimed in claim 1, wherein at least the outer layer C has been pigmented.

7. The transparent film as claimed in claim 1, which has been in-line coated on at least one side.

8. The transparent film as claimed in claim 1, which has been ceramic-coated or metallized on the outer layer A.

9. A process for production of the film as claimed in claim 1, comprising the steps of:
(i) producing a film comprising a base and outer layer(s) via coextrusion,
(ii) biaxially stretching the film, and
(iii) heat-setting the stretched film, wherein said biaxially stretching comprises stretching the film longitudinally at a temperature in the range from 80 to 130° C. and stretching the film transversely at a temperature in the range from 90 to 140° C., and using a longitudinal stretching ratio in the range from 2.0:1 to 5.0:1, and using a transverse stretching ratio in the range from 2.5:1 to 5.0:1.

10. The process as claimed in claim 9, wherein an amount of up to 60% by weight, based on the total weight of the film, of cut material produced during film production is reused as regrind for film production.

11. Food or consumable item packaging comprising a film as claimed in claim 1.
